(19) United States
(12) Patent Application Publication
(10) Pub. No.: US 2016/0303775 A1
(43) Pub. Date: Oct. 20, 2016

(54) METHOD FOR HIGHLY CONDUCTIVE GRAPHENE-BASED SEGREGATED COMPOSITES

(71) Applicant: Rhode Island Board of Education, State of Rhode Island and Providence Plantations, Providence, RI (US)

(72) Inventors: Nicholas Heeder, Saunderstown, RI (US); Fei Guo, Cambridge, MA (US); Arun Shukla, Wakefield, RI (US); Robert Hurt, Providence, RI (US); Arijit Bose, Lexington, MA (US); Anubhav Tripathi, Northborough, MA (US)

(21) Appl. No.: 14/576,782

(22) Filed: Dec. 19, 2014

Related U.S. Application Data
(60) Provisional application No. 61/918,134, filed on Dec. 19, 2013.

(51) Int. Cl. B29C 43/00; C08J 3/20; C08K 3/04; H01B 1/24

(52) U.S. Cl. CPC B29C 43/003; H01B 1/24; C08J 3/20; C08K 3/04; C08J 2325/06; C08K 2201/001; C08K 2201/005; C08K 2201/013; B29L 2009/00

(57) ABSTRACT

A method is disclosed of dispersing conductive particles within a polymer. The method includes the steps of providing dry polymer particles, adding conductive material to the dry polymer particles to coat the dry polymer particles, and hot melt pressing the coated polymer particles.

### CROSS REFERENCE TO RELATED APPLICATION

This application claims priority from U.S. Provisional Application Ser. No. 61/918,134 filed Dec. 19, 2013, the entire content and substance of which is incorporated by reference herein in its entirety.

### BACKGROUND

Electrical conductivity in polymers that are traditionally insulating can be achieved by dispersing conducting particles within the non-conducting matrix. The predicted percolation threshold for randomly aligned and uniformly dispersed 2-dimensional sheets such as graphene (aspect ratio ˜4000) in a matrix is 0.01% by volume. Achieving this threshold is difficult, because strong van der Waals interactions between these sheets lead to aggregation. In addition, most processing techniques, especially at the pilot and commercial scales, result in highly anisotropic flow's, which tend to align sheets along the direction of flow and inhibit the formation of a percolating network. Achieving the theoretical percolation limit for scalable techniques has therefore been difficult. Because of the energy demand for removing solvents, and sometimes their potentially hazardous nature, melt processing is often chosen over solvent based mixing of filler and polymer, despite the increased viscosity of a melt. Dispersing high aspect ratio sheets isotropically in a melt of high viscosity is a major challenge.

An alternate method for creating a connected pathway for conductive particles is to make segregated composites. The conductive particles within segregated composites are only permitted to reside on the surfaces of the polymer matrix particles. When consolidated into a monolith, these conductive particles become connected in a three-dimensional network, dramatically increasing the conductivity of the composite. Sheets do not have to be distributed isotropically throughout a matrix to achieve percolation, overcoming a major limitation. This way of achieving three-dimensional connectivity of the particles also decreases the contact resistance between the particles.

Multi-walled carbon nanotube (MWCNT)/high density polyethylene (HDPE) and graphene nanosheets (GNS)/HDPE) composites have also been prepared with a segregated network structure by alcohol-assisted dispersion and hot-pressing. The electrical properties of the GNS/HDPE and MWCNT/HDPE composites were compared and it was found that the percolation threshold of the GNS/HDPE composites (1% v/v) was much higher than that of the MWCNT/HDPE composites (0.15% v/v) while the MWCNT/HDPE composite showed higher electrical conductivity than the GNS/HDPE composite at the same filler content. It was concluded that, due to crimp, rolling and aggregation of the GNSs in the HDPE matrix, the two-dimensional GNSs were not as effective as MWCNTs in forming conductive networks.

Later, graphene/polyethylene segregated composites were prepared using a two-step process. A combination of sonication and mechanical mixing was used to first coat the ultrahigh molecular weight polyethylene (UHMWPE) with graphene oxide (GO) sheets. The excess solvent was removed from the system and then the coated powders were added to a hydrazine solution and stirred at 95° C. to reduce the GO to graphene. All coated powders were compressively molded and hot pressed to form composite sheets. This two-step process was shown to effectively prevent aggregation, leading to composites exhibiting high electrical conductivity at a very low percolation threshold (0.028% v/v). Even though the previously mentioned processes let to improved particle dispersion within polymers, all require the use of harsh solvents and are not commercially viable.

There remains a need therefore, for an improved method of providing dispersed electrically conductive particles in a polymer.

### SUMMARY

In accordance with an embodiment, the invention provides a method of dispersing conductive particles within an polymer. The method includes the steps of providing dry polymer particles, adding conductive material to the dry polymer particles to coat the dry polymer particles, and hot melt pressing the coated polymer particles.

### BRIEF DESCRIPTION OF THE DRAWINGS

The following description may be further understood with reference to the accompanying drawings in which:

FIGS. 1A-1D show illustrative micrographic representations of polystyrene (FIG. 1A), polystyrene coated with 0.05% v/v FLG (FIG. 1B), polystyrene coated with 0.1% v/v FLG (FIG. 1C), and polystyrene with less than 0.2% v/v FLG (FIG. 1D) for use in accordance with an embodiment of the present invention;

FIG. 2 shows an illustrative diagrammatic view of a procedure for wetting a surface in accordance with an embodiment of the present invention;

FIGS. 3A and 3B show illustrative micrographic representations of a top surface (FIG. 3A) and a cross-section (FIG. 3B) of a 0.05% v/v FLG/PS composite in accordance with an embodiment of the present invention;

FIG. 4 shows an illustrative graphical representation of electrical conductivity of FLG/PS composite material for varying amounts of volume % graphine in accordance with an embodiment of the present invention; and

FIG. 5 shows an illustrative micro-graphic representation of a scanning electron micrographic image of a 5% v/v FLG/PS segregated composite in accordance with an embodiment of the present invention.

### DETAILED DESCRIPTION

In accordance with various embodiments of the invention, it has been discovered that capillary interactions between polystyrene (PS) particles and few-layer graphene (FLG) particles are used to coat the FLG onto the polymer. It has further been discovered that hot pressing these coated particles results in highly conductive composites. Electrical percolation below 0.01% v/v of FLG has been obtained. A significant increase in electrical conductivity is observed for the composites between 0.01% v/v and 0.3% v/v. The fabrication technique demonstrated here is straightforward, commercially viable and does not require hazardous chemicals. It provides the means to form highly organized conductive networks throughout insulating polymeric materials.

In accordance with particular embodiments, capillary-driven particle level templating and hot melt pressing to disperse few-layer graphene (FLG) flakes within a polystyrene matrix was used to enhance the electrical conductivity of the polymer. The conducting pathways provided by the graphene located at the particle surfaces through contact of the bounding surfaces allow percolation at a loading of less than 0.01% by volume. This novel method of distributing graphene within a matrix overcomes the need to disperse the sheet-like conducting fillers isotropically within the polymer, and can be scaled up easily.

In this invention, a surprisingly direct, inexpensive and commercially viable technique was developed that can be used to disperse conductive sheet-like particles, such as graphene, into a highly organized pattern within polymeric materials on either the micro- or macro-scale. Utilizing capillary interactions between polymeric particles and few-layer graphene particles, liquid bridges on the surface of a polymeric material allows for coating of graphene onto the polymer surfaces. By precisely controlling the temperature and pressure during the melt compression process, highly conductive composites are formed using very low loadings of graphene particles. Applications for such composites could include sensing devices, coloring mechanisms, as well as barrier mechanisms.

### EXAMPLE 1

### Preparation of FLG/PS Segregated Composites

The few-layer graphene flakes used in this study were xGnP™ Nanoplatelets (XG Sciences, USA). These nanoparticles consist of short stacks of graphene layers having a lateral dimension of ˜25 μm and a thickness of 6 nm. The polymeric material chosen for this study was polystyrene (Crystal PS 1300, average molecular weight of 121,000 g/mol) purchased from Styrolution, USA. The PS pellets (˜2 mm) used were elliptical prisms with a total surface area of 1.03±0.01 cm².

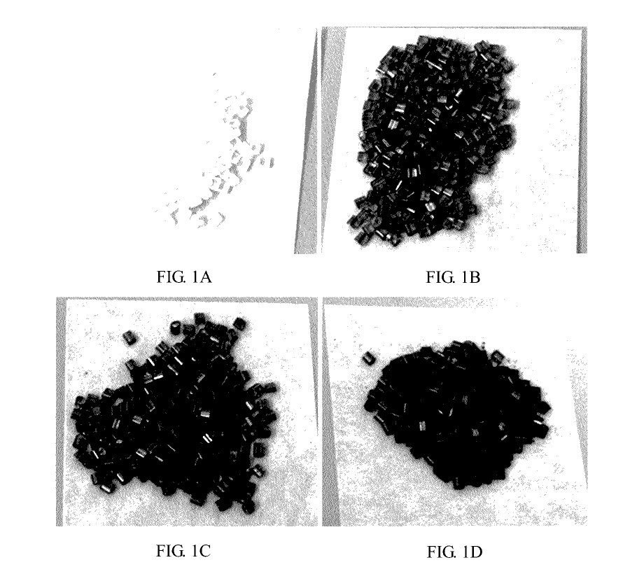

A two-step process was utilized to produce the FLG/PS segregated composites. First, the desired amount of graphene platelets were measured and added to 7 g of dry PS pellets. The FLG spontaneously adheres to the dry polymer particles by physical forces, which may be van der Waals forces or electrostatic attraction associated with surface charges. FIG. 1 shows PS pellets coated with various amounts of FLG using this dry coating process. This coating process works well for FLG loadings below 0.2% v/v. However, at higher FLG loadings, this dry method leaves behind excess FLG because the charge on the pellets is neutralized after the initial coating.

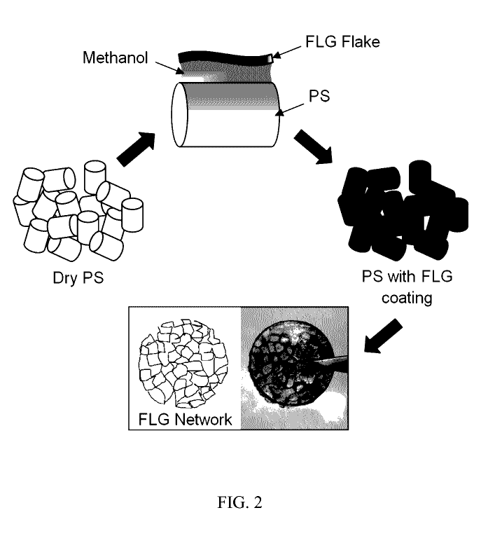

To provide a means of temporarily attaching larger quantities of the FLG to the surface of the PS, an additional step is implemented during the fabrication procedure, shown in FIG. 2. The PS is first soaked in a methanol bath and the excess methanol is drained from the PS pellets. FLG is added, and the mixture is then shaken vigorously, creating a dense coating of graphene on each PS pellet. The methanol temporarily moistens the polymer pellets forming small liquid bridges. The capillary pressure created through these bridges allows the FLG sheets to stick easily to the surface of the pellets. During the subsequent hot melt pressing, the temperature and mold pressure are precisely controlled allowing the pellets to be consolidated into a monolith while maintaining boundaries. The methanol evaporates during the molding cycle. In our experiments, a stainless steel mold consisting of a lower base and a plunger was heated to 110° C. The graphene-coated PS was placed inside the cavity of the lower base and the plunger was placed on top. The temperature of both the plunger and the base mold was increased to 190° C. at which point it was hot-pressed at 45 kN using a hydraulic press.

### EXAMPLE 1

### Analyses of FLG/PS Segregated Composites

Electrical conductivity measurements were made on the FLG/PS composites using a volumetric two-point probe measurement technique. The bulk electrical conductivity was measured across the thickness of the sample (perpendicular to pressing). The resistance of the material was experimentally determined by supplying a constant current, ranging from 5 nA to 1 mA, through the specimen while simultaneously measuring the voltage drop across the specimen. A constant current source (Keithley Instruments Model 6221) was used to supply the DC current while two electrometers (Keithley Instruments Model 6514) were used to measure the voltage drop. The difference between the two voltage readings was measured using a digital multimeter (Keithley Instruments Model 2000 DMM).

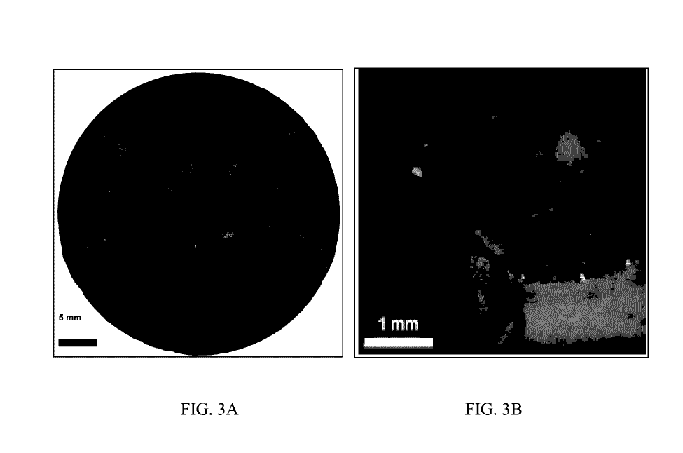

As seen in FIG. 2, the composite (with 0.3% v/v FLG) has a foam-like structure in which the dark wall-like structures are FLG while the lighter domains are the PS. Images of a 0.05% v/v FLG/PS composite exhibiting this segregated structure are shown in FIG. 3.

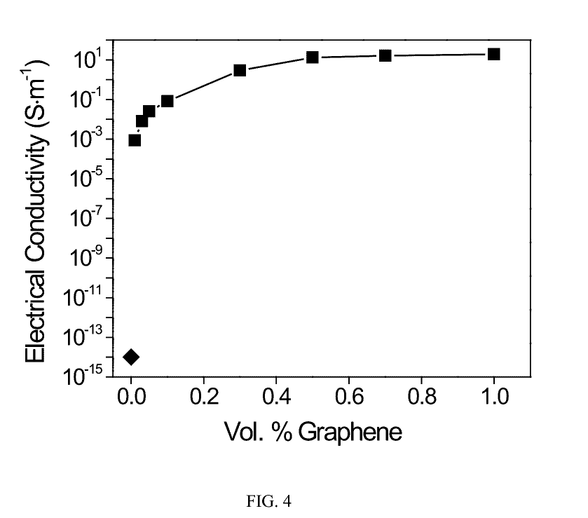

FIG. 4 shows the electrical conductivity as a function of graphene loading. A significant enhancement in electrical conductivity is demonstrated when 0.01% v/v FLG was added to the PS. Since the boundaries located between the pellets are maintained, the graphene particles become interconnected throughout the material thus causing a significant increase in conductivity while using very low loadings of graphene. The capillary driven coating process enables more graphene to completely coat the surface of the PS, which in turn increases the electrical conductivity of the composite approximately 4-5 orders of magnitude from 0.01 to 0.3% v/v.

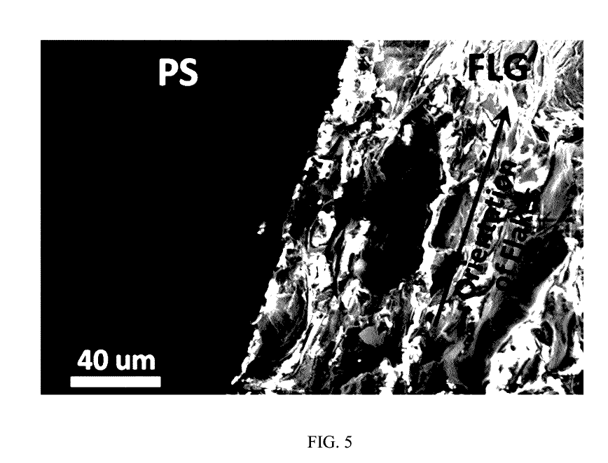

A scanning electron microscope (SEM) image showing a section view of a 5% v/v FLG/PS segregated composite is shown in FIG. 5. It appears that the majority of the graphene particles are oriented along the PS-PS interface. This alignment of the large graphene sheets enables efficient utilization of the high aspect ratio while also allowing for efficient electron transfer between the graphene particles. These micro-scale interactions further contribute to the exceptional conductivity demonstrated at very low loading fractions.

What is claimed is:

1. A method of dispersing conductive particles within an polymer, said method comprising the steps of
providing dry polymer particles;
adding conductive material to the dry polymer particles to coat the dry polymer particles; and
hot melt pressing the coated polymer particles.

2. The method as claimed in claim 1, wherein said method further includes the step of soaking the coated polymer particles in a methanol bath, and draining excess methanol from the coated polymer particles.

3. The method as claimed in claim 2, wherein the methanol evaporates during the hot melt pressing step.

4. The method as claimed in claim 1, wherein said step of hot melt pressing the coated polymer particles involves the use of a mold.

5. The method as claimed in claim 1, wherein the conductive material is graphene.

6. The method as claimed in claim 1, wherein the conductive material is few-layer graphene flakes.

7. The method as claimed in claim 1, wherein the conductive material includes short stacks of graphene layers having a lateral dimension of ˜25 μm.

8. The method as claimed in claim 1, wherein the conductive material includes short stacks of graphene layers having a thickness of ˜6 nm.
